(19) United States
(12) Patent Application Publication
(10) Pub. No.: US 2003/0205515 A1
(43) Pub. Date: Nov. 6, 2003

(54) Sanitary seal for modular chromatography columns

(76) Inventors: Geoffrey Purdom, Acton, MA (US); Melvyn John Gill, Gloucestershire (GB); Anthony Frederick Mann, Malmesbury (GB)

Correspondence Address: MILLIPORE CORPORATION, 290 CONCORD ROAD, BILLERICA, MA, 01821, US

(21) Appl. No.: 10/371,904

(22) Filed: Feb. 20, 2003

Related U.S. Application Data
(60) Provisional application No. 60/361,540, filed on Mar. 4, 2002.

(51) Int. Cl. B01D 15/08

(52) U.S. Cl. 210/198.2; 435/287.2; 435/287.1; 73/61.52

(57) ABSTRACT

A sanitary static seal for the fixed end of a chromatography column is described. The seal is in the form of an “L” or a “U” so as to form a seal against at least one major surface of the frit or screens and the outer peripheral edge of the frit or screen. In this way, any bypass is prevented and the potential for dead spaces such as O-ring grooves is eliminated thereby reducing the potential for bacteria or mold growth in the system. The gasket maybe formed separately and placed on the edge of the frit or screen or it may be molded in place.

The present invention relates to a sanitary seal for use in chromatography columns. More particularly, it relates to a sanitary seal for the fixed end of a chromatography column, preferably a modular column.

### BACKGROUND OF THE INVENTION

Chromatography columns have been used for years for the separation and/or purification of different materials such as proteins.

These columns are formed of three basic components; a column cylinder, a bottom fixed end and a top, movable end. See U.S. Pat. No. 4,350,595 and U.S. Pat. No. 6,139,732. The top end moves relative to the cylinder so as to be capable of removal for introduction and removal of chromatography media in the cylinder and to be capable of longitudinal travel into the cylinder to compress the media for use.

The top end contains one or more seals, typically O-rings, wiper seals or inflatable seals that are used to maintain a seal between the top end and the inner wall of the column. The bottom end is fixed in place to the column either through a flange that is formed as part of the column or separate flange which connects the column to the end plate.

This bottom end does not move and is only removed from the column for repair or normal maintenance. It however must have a liquid tight seal, typically at higher than atmospheric pressures (2 to 14 bar are typical). It also has a bottom screen that keeps the media in the column and yet allows fluid to flow out through the outlet in the bottom of the column. This screen is commonly in the form of a sintered metal or plastic porous frit or a series of metal screens that have been calendared together to form a unified layer. The seal used is traditionally one or more O-rings placed between either one side of the frit or screen or both sides of the frit or screen and the flange and the column.

This arrangement is represented in FIG. 1 by a partial cross section of the lower end of a typical column where the frit 2 is sandwiched between an O-ring 4 and the bottom plate 8 and the flange 10 of the column 12 and the assembly is compressed by a series of bolts 13 between the bottom plate 8 and the flange 10. As shown, the O-ring 4 is retained within groove 14 to keep it in its proper position during assembly. This O-ring prevents leakage of media beyond the column bed. A second O-ring 6 in a groove 16 is outboard of the first O-ring and is compressed between the bottom plate 8 and the flange 10 to prevent liquid bypass.

The frit or the screens are porous in order to allow the fluid to move through them to the outlet 18. Additionally, they are somewhat rigid in order to resist the weight of the media and the pressures applied to the system. The pores of the frit or screens are not linear or uniform, but are tortutious and extend horizontally as well as vertically. Lastly, the spaces in the grooves for the O-rings represent potential dead spots in which bacteria, mold and the like can reside and grow unchecked, leading to contamination of the system. One can disassemble the bottom end after use and clean the grooves and gaskets, but this is time consuming and costly. A better alternative is needed.

The present invention provides that solution.

### SUMMARY OF THE INVENTION

The present invention relates to a sanitary static seal for the fixed end of a chromatography column. The seal is in the form of an “L” or a “U” so as to form a seal against at least one major surface of the frit or screens and the outer peripheral edge of the frit or screen. In this way, any bypass is prevented and the potential for dead spaces such as O-ring grooves is eliminated thereby reducing the potential for bacteria or mold growth in the system. The gasket maybe formed separately and placed on the edge of the frit or screen or it may be molded in place.

It is a first object of the present invention to provide a sanitary seal for a chromatography column comprising a seal in the shape selected from the group consisting of an L and an U, said seal being interposed between an end of a frit, a flange of the column cylinder and a bottom plate of the column under compression.

It is a second object of the present invention to provide a chromatography column having a bottom plate, a movable top plate, a column cylinder attached to the bottom plate, a frit interposed between the cylinder and the bottom plate and one or more seals interposed between the cylinder and frit wherein the improvement comprises the seal is in the form of an L or an U and is located at the outer edge of the frit.

It is a third object of the present invention to provide a sanitary seal for a fixed bottom of a chromatography column comprising a seal in the form of an L or a U and the seal is formed in place on a frit or screen interposed between the column cylinder wall and the column bottom plate.

### IN THE DRAWINGS

FIG. 1 shows a cross sectional view of the bottom end arrangement of a column according to the prior art.

FIG. 2 shows a cross sectional view of the bottom end arrangement of a column according to a first embodiment of the present invention.

FIG. 3 shows a cross sectional view of the bottom end arrangement of a column according to a second embodiment of the present invention.

FIGS. 4, 5 and 6 show cross sectional views of the seals according to additional embodiments of the present invention.

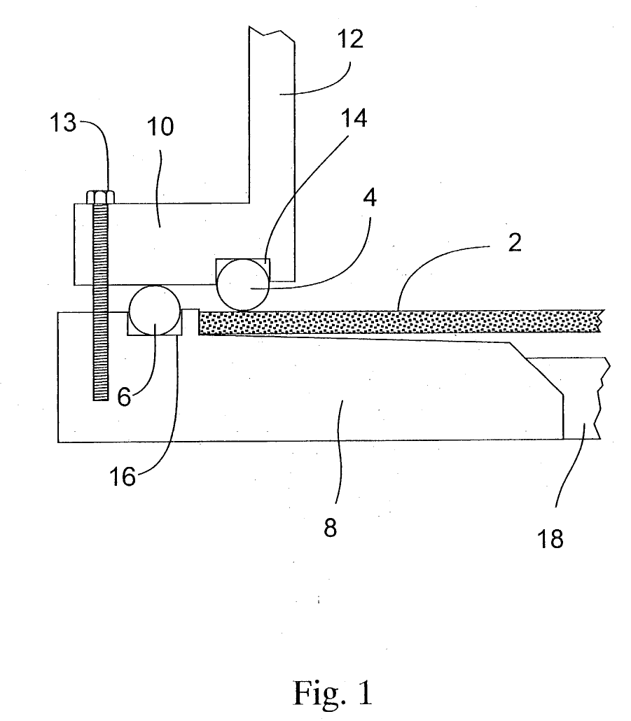

### DETAILED DESCRIPTION OF THE SPECIFICATION

The present invention relates to a sanitary static seal for the fixed end of a chromatography column. The seal is in the form of an “L” or a “U” so as to form a seal against at least one major surface of the frit or screens and the outer peripheral edge of the frit or screen.

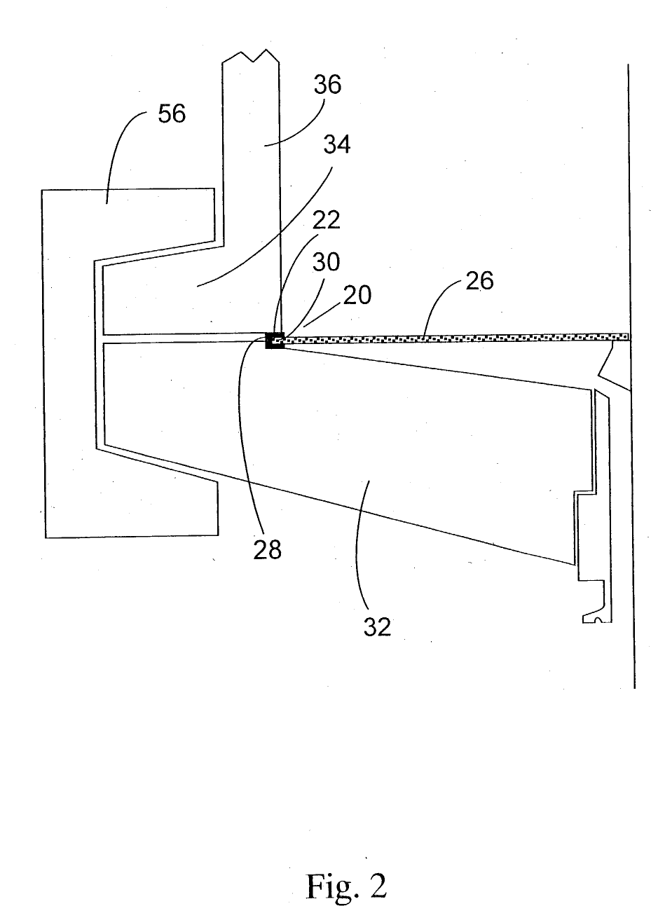

FIG. 2 shows a cross sectional view of the bottom end arrangement of a column according to a first embodiment of the present invention. In this arrangement, the seal 20 is in the form of a “U” such that each arm 22, 24 extends over a portion of the outer edge of the frit or screen 26. The central connecting portion 28 between the two arms 22, 24 covers the outer peripheral edged 30 of the frit or screen 26. The seal 20 and frit or screen's 26 outermost portion is positioned between the column bottom plate 32 and the column flange 34. In this embodiment, the flange is formed as an integral part of the column cylinder 36. Alternatively, the flange 34 may be a separate piece as is known in the art. A clamp 38, such as a Ladish clamp can be used to hold the flange 34 to the bottom plate 32 and to compress the seal 20. Alternatively, nuts and bolts or bolts and threaded receivers in one of the components can be used if desired.

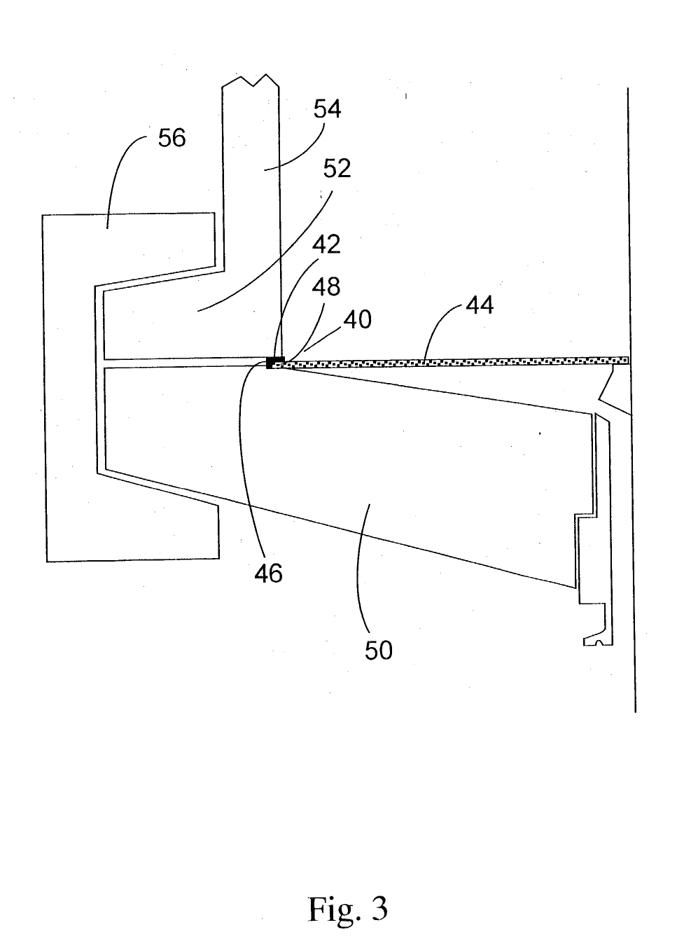

FIG. 3 shows a cross sectional view of the bottom end arrangement of a column according to a second embodiment of the present invention. In this arrangement, the seal 40 is in the form of an “L” such that the longer arm 42 extends over a portion of the outer edge of the frit or screen 44. The shorter arm or the horizontal portion of the “L” 46 covers the outer peripheral edge 48 of the frit or screen 44. The seal 40 and frit or screen's 44 outermost portion is positioned between the column bottom plate 50 and the column flange 52. In this embodiment, the flange is formed as an integral part of the column cylinder 54. Alternatively, the flange 52 may be a separate piece as is known in the art. A clamp 56, such as a Ladish clamp can be used to hold the flange 52 to the bottom plate 50 and to compress the seal 40. Alternatively, nuts and bolts or bolts and threaded receivers in one of the components can be used instead if desired to hold the flange to the bottom plate.

The seal of the present invention can be made of a variety of materials typically used for making resilient seals. These materials include but are not limited to natural rubber, synthetic rubbers, such as silicone rubbers, including room temperature vulcanizable silicone rubbers, catalyzed (such as by platinum catalysts) silicone rubbers and the like, thermoplastic elastomers such as SANTOPRENE® elastomers, polyolefins such as polyethylene or polypropylene, especially those containing gas bubbles introduced either by a blowing agent or entrained gas such as carbon dioxide, PTFE resin, thermoplastic perfluoropolymer resins such as PFA and MFA resins available from Ausimont, USA of Thorofare, N.J. and E. I. DuPont de Nemours of Wilmington, Del., urethanes, especially closed cell foam urethanes, KYNAR® PVDF resin, VITON® elastomer, EPDM rubber and blends of the above.

The seal may be formed as a continuous, single piece and stretched over and around the outer edge of the frit or screen or it may be formed of one or more linear pieces and butt jointed together with heat or adhesives. If desired, the gasket of the present invention may be bonded to the edge of the frit or screen by heat or adhesive. Alternatively, one could place or incorporate metal or plastic retaining clips into the interior of the seal, especially when in the “U” shape, to act as an attachment means of the gasket to the frit or screen.

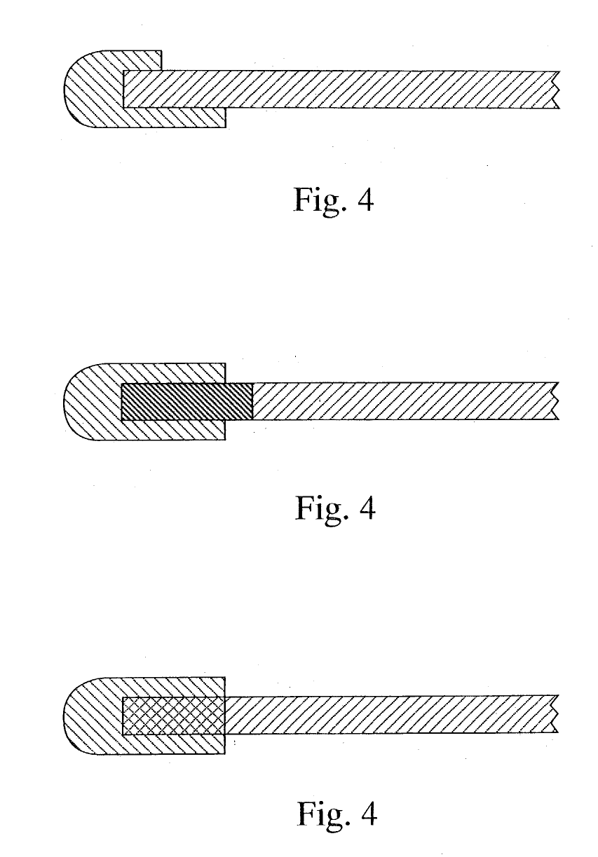

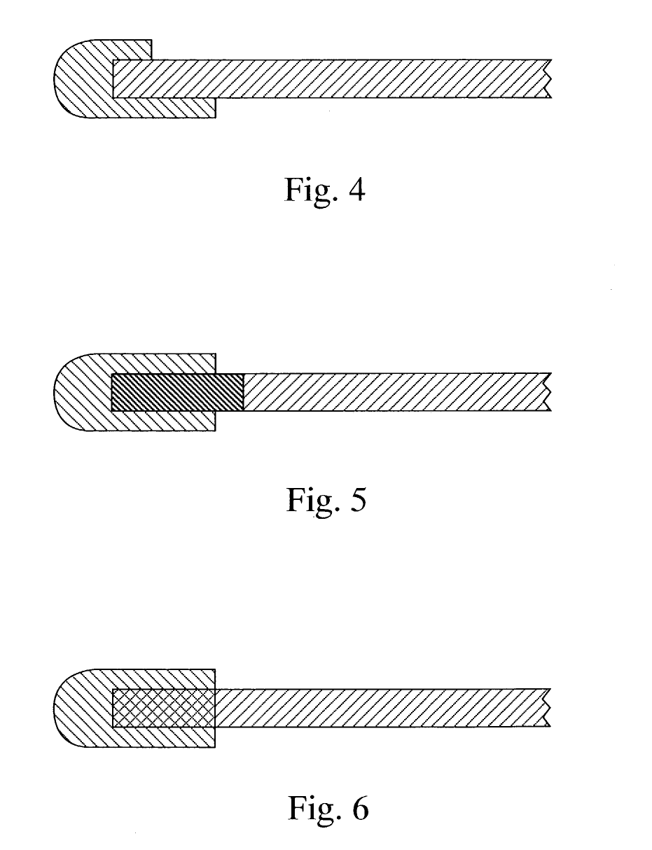

FIG. 4 shows another embodiment of the seal of the present invention. In this design, one leg of the “U” shape is of a different length than the other leg. It is applied to the frit or screen in the same way as that discussed above in relation to FIG. 2.

FIG. 5 shows a further embodiment of the seal and frit or screen of the present invention. In this embodiment, the outer peripheral portion of the frit or screen is rendered non-porous such as by filling the pores with a non-porous material including but not limited to plastic such as an epoxy, polyurethane, thermoplastic such as polyethylene or metal, such as tin or lead-free solder, white metal or the like, or it is compressed to render it substantially non-porous, or the outer portion is formed of a separate non-porous material such as a solid metal or plastic ring that is fused or bonded to the outer edge of the frit or screen. In this way, the lack of pores at the edge of the frit or screen eliminates the potential for any horizontal flow against the gasket. The gasket as shown can be a “U” shape or a “L” shape as desired.

In addition, the gasket can be formed in place on the outer edge of the frit or screen as shown in FIG. 6. The seal is molded in place onto and into (at least partially) the outer porous edge of the frit or screen. This provides a strong mechanical attachment of the seal to the frit or screen, eliminating any potential for misalignment or displacement during assembly. Additionally, it too seals of the pores at the edge preventing horizontal flow beyond the frit or screen and gasket.

A disadvantage is that if the seal needs to be replaced, the entire structure (seal and frit or screen) needs to be replaced, which is more expensive than replacing a seal by itself. However, it does have applications and uses in some situations, such as at higher pressures (the mechanical anchoring of the seal material into the pores of the frit or screen make it more difficult to dislodge with pressure) and where proper seal alignment is critical.

Suitable materials for such molded in place seals can be curable rubbers, such as room temperature vulcanizable silicone rubbers, thermoplastic elastomers such as SANTOPRENE® elastomers, polyolefins such as polyethylene or polypropylene, especially those containing gas bubbles introduced either by a blowing agent or entrained gas such as carbon dioxide. A mold is typically used to form the gasket into the desired shape around the edge. The gasket can be formed as a single unit or for costs, it may be formed in a series of moldings around the outer circumference of the frit or screen by a partial mold, utilizing the properties of the sealing material (heat, cure times, etc) to form a bond between adjoining sections.

### EXAMPLE

A chromatography column, according to the prior art using an O-ring seal (BPG 300 available from Amersham Biosciences) was used as a control. A second column according to the embodiment of FIG. 3 was assembled using the “U” shaped seal design.

A test fluid comprised of 2% phenol red dye, water and a salt (Sodium hydroxide to make the fluid slightly alkaline) was added to the media (MATREX® Cellufine Sulphate media available from Millipore Corporation of Bedford, Mass.) and stirred to ensure that the media was saturated with the dye.

Media was packed into each column and five column volumes of water was run through each bed to remove the dye. The systems were drained and disassembled. A visual inspection was made of the seals, the grooves, the screens and the flange and bottom housing for evidence of dye.

Dye was found in several locations near or in the O-ring grooves of the prior art system while no dye was found throughout the components of the system made according to the present invention. This test indicated that the seal of the present invention provided a more sanitary seal than the O-rings of the prior art and in particular it eliminated any stagnant areas in or around the seal which would be difficult or impossible to clean.

What we claim:

1) A sanitary seal for a chromatography column comprising a seal in the shape selected from the group consisting of an L and an U, said seal being interposed between an end of a frit, a flange of the column cylinder and a bottom plate of the column under compression.

2) The seal of claim 1 wherein the seal is in the form of a U and placed over the peripheral edge of the frit such that each arm of the U covers a portion of the peripheral edge of the frit.

3) The seal of claim 1 wherein the seal is formed of a compressive material selected from the group consisting of natural rubber, synthetic rubbers, crosslinked synthetic rubbers, vulcanized synthetic rubbers, thermoplastic elastomers, polyolefins, PTFE resin, thermoplastic perfluoropolymer resins, urethanes, EPDM rubbers, PVDF resin and blends thereof.

4) The seal of claim 1 wherein the seal is formed in place on the frit.

5) The seal of claim 1 wherein the seal is in the form of a U and is formed in place on the frit.

6) The seal of claim 1 wherein the seal is in the form of an L and is formed in place on the frit.

7) The seal of claim 1 wherein the seal is in the form of an L, is formed in place on the frit such that a longer arm of the L shape is formed on an upper surface of the frit and a shorter arm is formed on the outer peripheral vertical edge of the frit.

8) The seal of claim 1 wherein the frit is selected from the group consisting of sintered porous metal, sintered porous plastic, one or more layers of metal screen and one or more layers of plastic screen.

9) A chromatography column having a bottom plate, a movable top plate, a column cylinder attached to the bottom plate, a frit interposed between the cylinder and the bottom plate and one or more seals interposed between the cylinder and frit wherein the improvement comprises the seal is in the form of an L or an U and is located at the outer edge of the frit.

10) The improvement of claim 9 wherein the seal is in the form of an L and is formed in place on the frit.

11) The improvement of claim 9 wherein the seal is in the form of an L, is formed in place on the frit such that a longer arm of the L shape is formed on an upper surface of the frit and a shorter arm is formed on the outer peripheral vertical edge of the frit.

12) The improvement of claim 9 wherein the seal is in the form of a U and is formed in place on the frit.

13) The improvement of claim 9 wherein the seal is in the form of an U and placed over the peripheral edge of the frit such that each arm of the U covers a portion of the peripheral edge of the frit.

14) The seal of claim 1 wherein the frit has an outer peripheral portion rendered non-porous.

15) The seal of claim 1 wherein the frit has an outer peripheral portion rendered non-porous by a method selected from the group consisting of filling the pores of the outer peripheral portion with a non-porous material, compressing the outer peripheral portion or forming the outer peripheral portion of a non-porous material.

16) The seal of claim 1 wherein the seal is in the form of an L, is formed in place on the frit such that a longer arm of the L shape is formed on a lower surface of the frit and a shorter arm is formed on the outer peripheral vertical edge of the frit.

17) The improvement of claim 9 wherein the seal is in the form of an L, is formed in place on the frit such that a longer arm of the L shape is formed on a lower surface of the frit and a shorter arm is formed on the outer peripheral vertical edge of the frit.

18) The improvement of claim 9 wherein the frit has an outer peripheral portion rendered nonporous.

19) The improvement of claim 9 wherein the frit has an outer peripheral portion rendered nonporous by a method selected from the group consisting of filling the pores of the outer peripheral portion with a non-porous material, compressing the outer peripheral portion or forming the outer peripheral portion of a non-porous material.
